(19) United States
(12) Patent Application Publication
(10) Pub. No.: US 2009/0313324 A1
(43) Pub. Date: Dec. 17, 2009

(54) INTERACTIVE VIEWING OF MEDIA CONTENT

(75) Inventors: Levee Brooks, East Orange, NJ (US); Vivek Arun Bidwai, Salt Lake City, UT (US); Anil Goyal, San Ramon, CA (US); Steve Perlow, Arlington, VA (US)

Correspondence Address: SHUMAKER & SIEFFERT, P. A., 1625 RADIO DRIVE, SUITE 300, WOODBURY, MN, 55125, US

(73) Assignee: Deucos Inc., New York, NY (US)

(21) Appl. No.: 12/480,305

(22) Filed: Jun. 8, 2009

Related U.S. Application Data
(60) Provisional application No. 61/073,210, filed on Jun. 17, 2008.

(51) Int. Cl. G06F 15/16

(52) U.S. Cl. 709/203; 707/10

(57) ABSTRACT

This disclosure describes a network system that provides media content to a user. The user may become stimulated by the media content and desire to receive information about the media content that stimulated the user's interest. This disclosure describes techniques providing information regarding events within the media content that stimulated the user's interest, i.e., stimuli information.

This application claims the benefit of U.S. Provisional Application Ser. No. 61/073,210 filed Jun. 17, 2008, the entire contents of which is incorporated herein by reference.

### TECHNICAL FIELD

This disclosure relates to network systems that provide user desired content.

### SUMMARY

In general, the invention provides users, e.g., viewers of media content, with the ability to receive information about media content that stimulated the users' interest. A user downloads media files that include media content such as media content from a media content provider and views the media content on a user device. While viewing the media file, the user may be stimulated by some media content within a scene of the media file. For example, the user views a particular consumer product displayed within the scene and becomes interested in knowing information about the product such as locations of where to purchase the consumer product.

The media file is generally a collection of ordered scenes that are sequentially displayed to the user via a media player. Each scene comprises one or more frames and contains a portion of the entire media content associated with the media file.

In accordance with the invention, after being stimulated by a scene within the media file, the user causes a user device to transmit metadata information about the scene to a server. The user may immediately cause the user device to transmit the metadata, or alternatively, the user may wait until the end of the media content to transmit the metadata. The metadata may comprise an identification of the media file, as well as, a timestamp of when the scene occurred or the scene number. The scene number is a number that defines a location of the scene within the media file. Based on the received metadata, the server parses through its memory to find stimuli information associated with the scene within the media file. The server then transmits possible stimuli information back to the user device. Some examples of stimuli information includes consumer products, audio element, e.g., audio information, an identification of cast and crew, e.g., cast and crew information, location element, e.g., location information, a narrative content element, educational items, and the like.

In one embodiment, the invention is directed to a method. The method comprises displaying media content of the media content file on a user device. The method further comprises receiving a user selection for a scene of the media content in response to a stimulus within the media content and extracting metadata associated with the selected scene. The method further comprises transmitting the metadata to a server.

In another embodiment, the invention is directed to a method. The method comprises receiving metadata from a user device. The metadata includes identification of a media content file. The method further comprises determining a scene within the media content file based on the metadata, and determining stimuli information associated with one or more stimuli within the media file. The method further comprises transmitting the stimuli information to the user device.

In another embodiment, the invention is directed to a method. The method comprises receiving a media content file comprising a plurality of scenes. The method further comprises extracting metadata from each one of the plurality of scenes and extracting one or more stimuli from each one of the plurality of scenes. The method further comprises generating stimuli information for each one of the one or more extracted stimuli, associating the stimuli information for each one of the plurality of scenes with the extracted metadata for each one of the plurality of scenes, and storing the associated stimuli information and the extracted metadata for the media content file.

In another embodiment, the invention is directed to a computer-readable storage medium. The computer readable storage medium comprises instructions that cause one or more processors to display media content of the media content file on a user device. The instructions further cause the one or more processors to receive a user selection for a scene of the media content in response to a stimulus within the media content and extract metadata associated with the selected scene. The instructions further cause the one or more processors to transmit the metadata to a server.

In another embodiment, the invention is directed to a computer-readable storage medium. The computer-readable storage medium comprises instructions that cause one or more processors to receive metadata from a user device. The metadata includes identification of a media content file. The instructions further cause the one or more processors to determine a scene within the media content file based on the metadata, and determine stimuli information associated with one or more stimuli within the media file. The instructions further cause the one or more processors to transmit the stimuli information to the user device.

In another embodiment, the invention is directed to a computer-readable storage medium. The computer-readable storage medium comprises instructions that cause one or more processors to receive a media content file comprising a plurality of scenes. The instructions further cause the one or more processors to extract metadata from each one of the plurality of scenes and extract one or more stimuli from each one of the plurality of scenes. The instructions further cause the one or more processors to generate stimuli information for each one of the one or more extracted stimuli, associate the stimuli information for each one of the plurality of scenes with the extracted metadata for each one of the plurality of scenes, and store the associated stimuli information and the extracted metadata for the media content file.

In another embodiment, the invention is directed to a device. The device comprises a display module configured to display media content of the media content file on a user device. The device further comprises a transceiver configured to receive a user selection for a scene of the media content in response to a stimulus within the media content, and a processor configured to extract metadata associated with the selected scene. The processor causes the transceiver to transmit the metadata to a server.

In another embodiment, the invention is directed to a device. The device comprises a transceiver configured to receive metadata from a user device, wherein the metadata includes identification of a media content file. The device further comprises a processor configured to determine a scene within the media content file based on the metadata, and determine stimuli information associated with one or more stimuli within the media file. The processor causes the transceiver to transmit the stimuli information to the user device.

In another embodiment, the invention is directed to a device. The device comprises a transceiver configured to receive a media content file comprising a plurality of scenes. The device further comprises a processor configured to extract metadata from each one of the plurality of scenes, extract one or more stimuli from each one of the plurality of scenes, generate stimuli information for each one of the one or more extracted stimuli, associate the stimuli information for each one of the plurality of scenes with the extracted metadata for each one of the plurality of scenes. The device further comprises a memory configured to store the associated stimuli information and the extracted metadata for the media content file.

In another embodiment, the invention is directed to a system. The system comprises one or more user devices. Each one of the user devices comprises a display module configured to display media content of the media content file on a user device. The user devices further comprise a first transceiver configured to receive a user selection for a scene of the media content in response to a stimulus within the media content, and a first processor configured to extract metadata associated with the selected scene, wherein the processor causes the transceiver to transmit the metadata. The system further comprises a server. The server comprises a second transceiver configured to receive metadata from the one or more user devices. The metadata includes identification of a media content file. The server further comprises a second processor configured to determine a scene within the media content file based on the metadata and determine stimuli information associated with one or more stimuli within the media file. The processor causes the transceiver to transmit the stimuli information to the one or more user devices.

### BRIEF DESCRIPTION OF DRAWINGS

FIG. 1 is a bock diagram illustrating a network system for providing and viewing media content.

FIG. 2 is a block diagram illustrating a memory device within a server.

FIG. 3 is a block diagram illustrating a client device.

FIG. 4 is a flowchart illustrating an example operation of the client device.

FIG. 5 is a flowchart illustrating an example operation of the server.

FIG. 6 is a flowchart illustrating an example operation of storing stimuli information in the memory.

FIG. 7 is an example block diagram illustrating an overview of a viewer's process for viewing media content.

FIG. 8 is an illustration of a watching step of FIG. 7.

FIG. 9 is an illustration of an adding and clicking step of FIG. 7.

FIG. 10 is an illustration of a browsing step of FIG. 7.

FIG. 11 is an illustration of a learning step of FIG. 7.

FIG. 12 is an illustration of an interacting step of FIG. 7.

### DETAILED DESCRIPTION

When a viewer views media content, such as a television episode, the viewer may be interested in events in the media content. Advertisers, well aware of this fact, have begun to display products in the media content (product placement) as a way to generate interest in the products. Product placement provides advantages over standard advertising techniques. Standard advertising techniques interrupt the media content and force the viewer to view an advertisement of the product. Produce placement, on the other hand, advertises the product without the need to interrupt the media content.

Advertisers are focusing on product placement as their advertising technique rather than standard advertising techniques. With devices such as digital video recorders (DVRs) and TiVo, a viewer can record the media content and skip through the advertisements. However, product placement is incorporated in the media content itself and the viewer is far less likely to skip through the media content. Furthermore, broadcast networks such as American Broadcasting Company (ABC), National Broadcasting Company (NBC), CBS Broadcasting Inc. (CBS), Fox Broadcasting Company (FOX), and others distribute their most popular programs via the Internet with limited advertisements. Limited advertisements in the Internet broadcasts reduce the advertisers' ability to advertise their products. Product placement allows the advertiser to advertise the product in Internet broadcasts of media content.

Once the viewer is interested in an event in the media content, the viewer may wish to find more information about the event. As one example, a product displayed in a television episode may pique the viewer's interest and he or she may want to purchase the product. Finding sources that provide the product can be tedious and at times fruitless because product placement fails to provide the viewer with a source where he or she can purchase the item. To avoid the tedium of trying to find sources for the product, the viewer may simply never attempt to find sources for the product. Every time the viewer chooses not to find a source for the product, even though the viewer is interested in purchasing the product, the maker and provider of the product lose opportunity to make revenue.

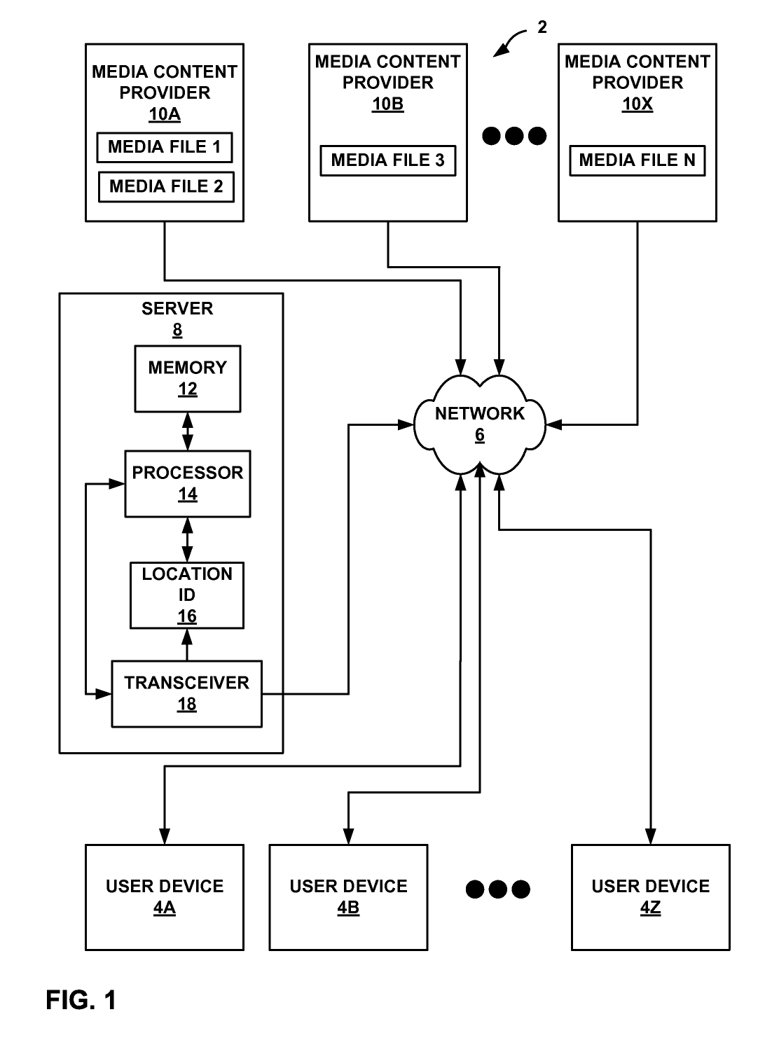

FIG. 1 is a block diagram illustrating a network system 2. System 2 includes user devices 4A-4Z (collectively referred to as user devices 4), network 6, server 8, and media content provider 10A-10X (collectively referred to as media content providers 10). Each one of user devices 4 may comprise a personal computer, television, personal digital assistant (PDA), mobile phone, web enabled Blu-Ray™ device, video game console, portable video gaming device, portable music device, portable data storage device and the like. Media content providers 10 store media files that contain media content. The media content may comprise a plurality of ordered scenes. Each scene may comprise one or more video frames. Each one of media content providers 10 may store one or more media files. For example, as shown in FIG. 1, media content provider 10A stores media file 1 and media file 2, media content provider 10B stores media file 3, and media content provider 10X stores media file N. The media files may be configured in a manner such that they can be displayed by user devices 4.

One of user devices 4 downloads a media file from one of media content providers 10 via network 6. For example, user device 4A downloads media file 1 from media content provider 10A, user device 4B downloads media file 2 from media content provider 10B, user device 4C downloads media file N from media content provider 10X, and so on. The term download encompasses embodiments where one of user devices 4 receives the entire media file and embodiments where one of user devices 4 streams the media file. Network 6 may comprise any of a wide variety of different types of networks. For example, network 6 may comprise the Internet, a content delivery network, a wide-area network, a proprietary network, a local area network (LAN), or another type of network. Network 6 may further include multiple smaller networks, including wireless or physical links to many types of devices.

While viewing a media file via a media player, a user may be stimulated by some stimuli within a scene of the media file, and may desire more information about the stimuli. Examples of stimuli include consumer products, audio information, cast and crew information, location information, narrative content, educational items, and the like. In accordance with the invention, after being stimulated, the user may click on a widget provided by the media player that causes the user device to transmit metadata about the scene to server 8. The metadata may comprise an identification of the media file, as well as, a timestamp of when the scene occurred or the scene number. The scene number is a number that defines a location of the scene within the media file.

Server 8 receives the transmitted metadata via transceiver 18. Transceiver 18 provides the metadata to location ID 16. Location ID 16 stores information regarding which one of client devices 4 transmitted the metadata. For example, location ID 16 stores the internet protocol (IP) address of the client device.

Transceiver 18 also provides the metadata to processor 14. Processor 14 may comprise a microprocessor that includes one or more cores, an application-specific integrated circuit (ASIC), co-processor, or another type of integrated circuit. Processor 14 may execute instructions stored in memory 12. When processor 14 executes instructions stored in memory 12, the instructions may cause processor 14 to perform one or more actions. Based on the received metadata, processor 14 parses through memory 12 to find stimuli information associated with the scene within the media file. Processor 14 then causes transceiver 18 to transmit the stimuli information to the client device that requested stimuli information based on the information stored location ID 14.

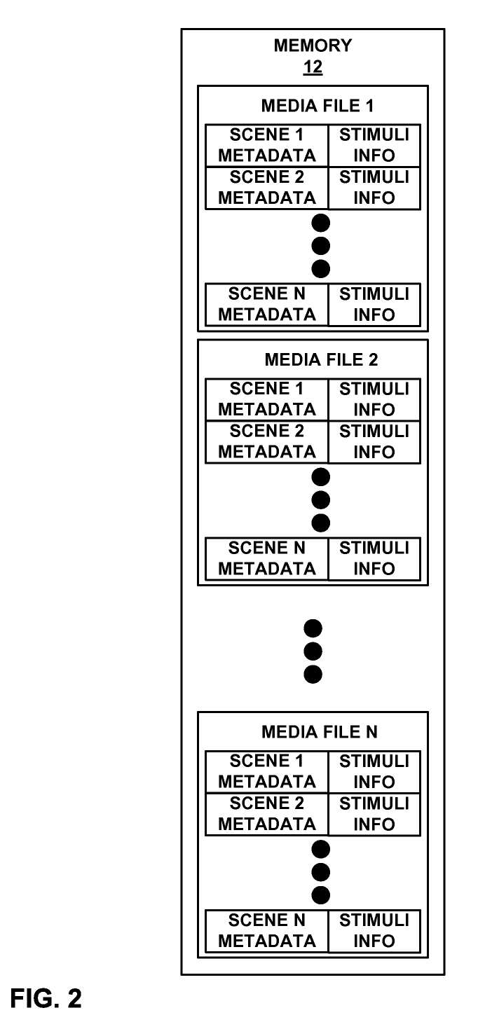

FIG. 2 is a block diagram illustrating memory 12 within server 8. As shown in FIG. 2, memory 12 stores metadata and stimuli information associated with each scene within a media file. Memory 12 stores this information for a plurality of media files. As described above, processor 14 (FIG. 1) parses through memory 12 to find stimuli information associated with a scene that stimulated the user.

The information stored in memory 12 is generated by extracting metadata for each scene within a media file followed by determining what type of stimuli is provided in each one of the scenes of the media file. It is important to note that the metadata extracted from each scene within a file and stored in memory 12 is different than the metadata provided by user devices 4 (FIG. 1). The metadata extracted from the media file includes information regarding the timestamp or scene number, e.g., locations of various scenes within the media content. The metadata transmitted by user devices 4 is an identification of the media file and a timestamp or scene number, e.g., location within the media file, that stimulated the user. Accordingly, the extracted metadata comprises a plurality of timestamps or scene numbers where each of the timestamps or scene numbers is associated with each one of the various scenes within the media content. The transmitted metadata comprises a location for a specific scene.

Subsequently, an individual or a group of people generate stimuli information for each one of the stimuli. In some examples, the stimuli information may be provided directly by media content providers 10 (FIG. 1). The stimuli information is then stored in memory 12. The stimuli information may comprise information about consumer products such as clothing and apparel, musical content, electronics, design (e.g. furniture, art, etc.), food (e.g. groceries, recipes, etc.), and print media (e.g. books, magazines, etc.) to name a few examples. Stimuli information may also comprise audio information such as songs, musical scores, ring tones, dialogue, intradiegetic & extradiegetic sounds to name a few examples. Stimuli information may also comprise cast and crew information such as information regarding characters/actors, directors, producers, writers, set designers to name a few examples. Stimuli information may also comprise locations such as shot location, film setting (e.g. a film set in Paris may be shot in an LA studio), and landmarks and tourist destinations (e.g. monuments, restaurants, bars, museums, etc.) to name a few examples. Stimuli information may also comprise narrative content such as information about scripts, narrative themes and plot lines, and cast and crew, to name a few examples. Stimuli information may also comprise education items such as information about characters, contemporary or historical information, filming techniques, and concepts, to name a few examples.

In some embodiments, information stored in memory 12 may be searchable without a transmission from client devices 4. The search functionality allows users to search for contextual information on stimuli within a specific episode, movie, or across all captured multimedia content. Conventional systems limit a user's search based only on the script. In accordance with the invention, rather than being limited in a search capability that is limited to a script, aspects of the invention empower the viewer to search video content by the visual stimuli that appear on screen, the audio stimuli that are heard, and the tagged metadata (e.g. comments, ratings, thematic discussions, etc.) that is generated by other users and captured in a database. Viewers can search for this data across all cataloged media content or within a specific title, scene, shot and/or frame.

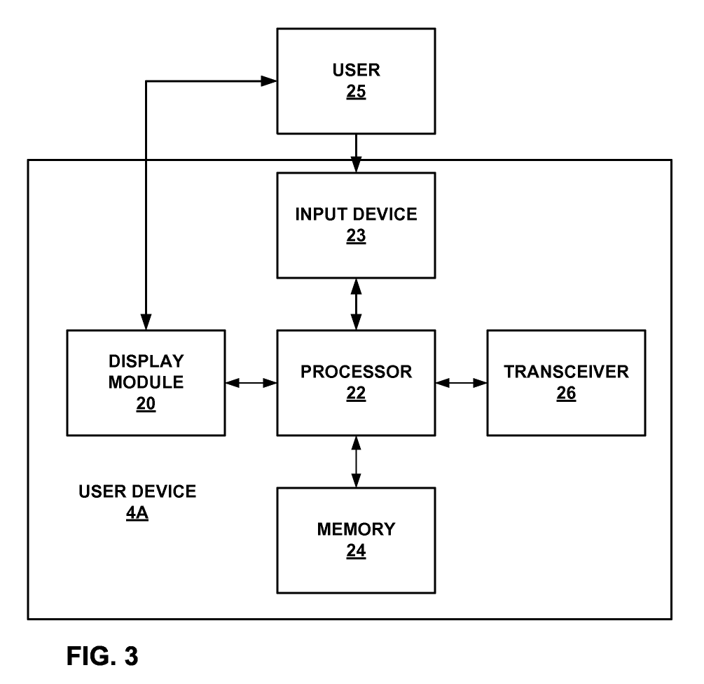

FIG. 3 is a block diagram illustrating one of client devices 4. FIG. 3 shows client device 4A; client device 4B-4Z may be substantially similar to client device 4A. Client device 4A includes display module 20, processor 22, memory 24, and transceiver 26. When user 25 wishes to view media content within a media file, in one embodiment, the user inputs a request to download the media file within display module 20. Alternatively, in another embodiment, the user inputs a request to download the media file to an input device 23. Subsequently, processor 22 causes transceiver 26 to download the requested media file from one of media content providers 10 (FIG. 1). Processor 22 may comprise a microprocessor that includes one or more cores, an application-specific integrated circuit (ASIC), co-processor, or another type of integrated circuit. Processor 22 may execute instructions stored in memory 24. When processor 22 executes instructions stored in memory 24, the instructions may cause processor 22 to perform one or more actions.

Processor 22 then causes display module 20 to display the media file. Display module 20 is software capable of displaying a media file. For example, in one embodiment, display module 20 comprises a Windows Media Player™.

When the user is stimulated by some stimuli within a scene of the media file, the user selects the scene that provided the stimulation. In one example embodiment, the user selects the screen by clicking on a widget provided by display module 20. In some embodiments, after the user selects the scene, processor 22 extracts the metadata for that particular scene and stores it in memory 24. In some embodiments, processor 22 causes transceiver 26 to immediately transmit the metadata stored in memory 24 to server 8 via network 6 (FIG. 1). In other embodiments, processor 22 causes transceiver 26 to transmit the metadata to server 8 at some later time chosen by the user, for example, at the end of the media file.

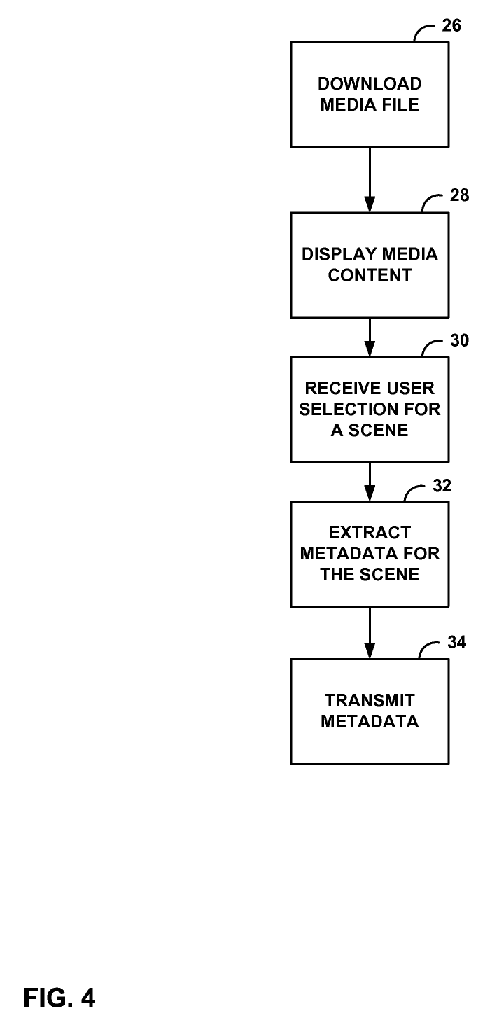

FIG. 4 is a flowchart illustrating an example operation of one of user devices 4. For clarity, FIG. 4 will be described with respect to the FIG. 3. User 25 inputs a command to either display module 20 or input device 23 to download a media file (26). In response, processor 22 causes transceiver 26 to download the desired media file from one of media content providers 10 (FIG. 1). After downloading the media file, or as the media file is being downloaded, display module 20 displays the media content within the media file to user 25 (28). When user 25 is stimulated by the media content, user 25 selects the scene that stimulated him or her (30). In one example, user 25 selects the scene by clicking on a widget provided by display module 20. However, this is just one example; different embodiments may provide different methods for user 25 to select the scene. After selecting the scene, processor 22 extracts metadata associated with the selected scene (32). As described above, the metadata may be the name of the media file and a timestamp of the scene or a scene number. In some embodiments, after processor 22 extracts the metadata, processor 22 may store the metadata in memory 24. Processor 22 may store the metadata in memory 24 in embodiments where user 25 desires to continue watching the media file even after he or she was stimulated by the media content. Processor 22 may cause transceiver 26 to transmit the metadata to server 8 (34). In some embodiments, processor 22 causes transceiver 26 to transmit the metadata immediately after processor 22 extracts the metadata. In some other embodiments, processor 22 causes transceiver 26 to transmit the metadata at the conclusion of the media file. In some other embodiments, processor 22 causes transceiver 26 to transmit the metadata only when user 25 desires to do so.

In some embodiments, where processor 22 causes transceiver 26 to transmit the metadata immediately after extracting the metadata, display module 20 may stop displaying the media file and allow user 25 to receive stimuli information. Display module 20 may provide user 25 with the option to either receive stimuli information immediately after user 25 is stimulated, or receive stimuli information at a later time when user 25 desires to receive information about the media content that stimulated him or her.

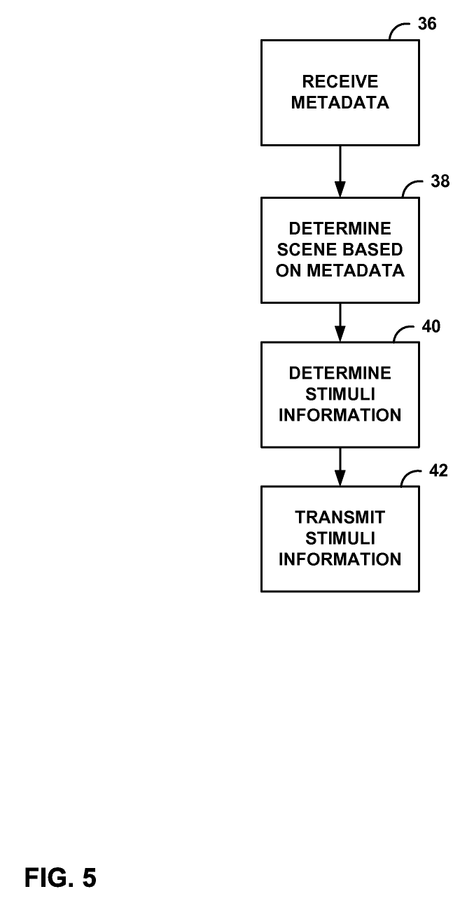

FIG. 5 is a flowchart illustrating an example operation of server 8. For clarity, FIG. 5 will be described with respect to FIG. 1. Server 8 receives metadata from one of client devices 4 via transceiver 18 (36). Location ID 16 stores information about the location of the client device 4 that transmitted the metadata. Processor 14 then determines which scene within the media file is associated with the received metadata (38). For example, server 8 may receive the media file name and either a timestamp or scene number within the media file. Based on the file name and either the timestamp or scene number, processor 14 determines which scene within the media file is associated with the received metadata. Processor 14 queries memory 12 to find stimuli information associated with the scene (40). Processor 14 then causes transceiver 18 to transmit the stimuli information to the client device (42). Transceiver 18 transmits the stimuli information to the client device based on the location of the client device stored in location ID 16.

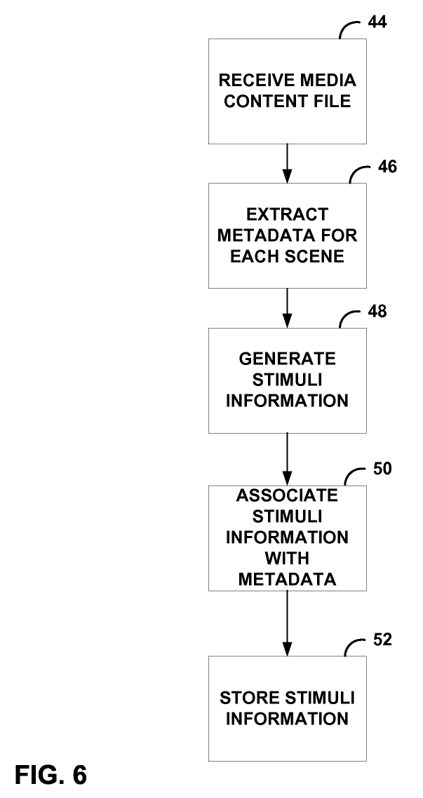

FIG. 6 is a flowchart illustrating an example operation of storing stimuli information in memory 12. For clarity, FIG. 6 will be described with respect to FIGS. 1 and 2. Server 8 receives a media file (44). Processor 14 extracts metadata for each one of the plurality of scenes within the media file (46). In some embodiments, an individual or a group of people view each scene within the media file and find stimuli contained within each scene. As described above, stimuli may be consumer products, audio, cast and crew, location, narrative content, educational items, and the like. The individual or the group of people generates information for each possible stimuli within each scene of the media file (48). The individual or the group of people associates the stimuli information with the extracted metadata (50). The stimuli information and the metadata are stored in memory 12 (52).

The following is a brief description of future trends in media content delivery recognized by the inventors. Following the description of future trends is a description of one non-limiting example of the service provided by Assignee's of this application (Deucos Inc.) in accordance with the invention described herein. In the description below, reference is made to Moogi.com, a website owned and operated by Deucos Inc.

Visual Media Industry: Current State and Outlook

Television:

Over the past twenty years, the act of viewing television has evolved dramatically. The production of video content for television has evolved with greater competition between production studios that create the video content, and the broadcast/cable networks that purchase and distribute the content.

Increase in competition is apparent in the improvement in quality of content produced and the quantity of content under production studios. Broadcast and cable networks are also willing to pay higher premiums for groundbreaking content which can appeal to diverse audience, but also encourage audience interaction with said content outside of traditional in-home means of content distribution. (CBS's “HIMYM”, NBC's “Heroes”, Fox's “House” and the CW's Gossip Girl”)

Over the past three years, in response to the growing popularity of the Internet (and, in particular, Web 2.0 technologies), broadcast networks have diversified their respective business models by beginning to distribute entertainment content online. ABC, CBS, FOX, NBC and the CW each distribute their most popular seasonal programs online. Fox and NBC have forged HULU, an online partnership particularly geared towards distributing content online. ABC recently indicated that it will loosen its grip on its online content by allowing outside web properties to embed its video content on their online sites.

This change in network behavior is influencing viewer behavior. The convenience afforded by online content is creating new ways for viewers to stay connected to their favorite network programming. The improvement of once-negative perceptions of television and cable content is apparent, also, in the groundbreaking roles that popular film actors are willing to take in television and cable programming.

Webisodes:

Over the past five years, the evolution of digital technology for shooting and editing video entertainment, and inexpensive online means of distributing such content to interested viewers has changed the film industry. Adobe's Flash technology is creating multiple opportunities and thus increasing competition within the content syndication and distribution space. Thus, video entertainment content is increasingly being viewed online.

Feature Cinema:

Feature cinema is perhaps the industry category within video entertainment which is seeing the slowest progression as it relates online content distribution. This is changing, however, as the traditional video rental model continues to be impacted by the evolution of iTunes and Netflix, and by the entry of streaming movie providers such as Amazon, Lycos Cinema and Jaman.

The changing competitive landscape presents much opportunity to capitalize on and distribute archived content online either through services' sales or rental platforms.

Video Games:

The distributing PC gaming products online is a long standing category of the content distribution business. However, as producers of gaming consoles become more connected with multimedia functionality and as game developers become more focused on tapping into online capabilities to create social networks around game properties, opportunities to further monetize information from within current and archived games will surface. Significant growth opportunity exists in video game metadata and product placement space.

Video Search:

An efficient means to search for information directly from within video content has not been developed in the prior art. Current technologies are capable of searching through texts and titles written about or surrounding the video platform, or in limited cases sounds from within the platform. However, search technology does not account for metadata from within the content.

Technology platforms under development will account for certain metadata features manually logged about soon-to-be-produced materials—e.g. music—but will not account for archived content. Much opportunity exists to develop a platform capable of storing metadata directly from within video content in order to create a more robust video search functionality.

Viewing Trends:

The changes outlined above continue to influence the visual media industry to take greater advantage of changing technologies and leverage new and growing distribution channels (e.g. Adobe Flash technology, iTunes and, eventually, Blockbuster and NetFlix) to deliver existing and future content in new ways.

Television: Led by ABC, CBS, FOX, NBC and the CW, major television networks are streaming episodes of video entertainment programming through web. Leveraging broadband technology and in may cases, HDTV as well, viewers are now able to watch most televised programs on the internet. This is a growing trend in the corporate behavior of broadcast and cable networks.

This trend has enabled a progressive increase in online viewing. A recent research study estimates that currently, approximately 10% of television viewers also currently watch network programming through online medium. Online viewership is expected to realize a 5% year-on-year increase for the next five years. By 2025, the same research study estimates that roughly 25% of television audiences will watch their favorite network programs online.

Feature Cinema: Movie studios have recently adopted BluRay as the new format for High Definition film storage and distribution. However, as companies like NetFlix and a growing number of On Demand vendors upset the traditional model of film rental, studios are experimenting with streaming video and video downloads to computers, televisions, cellular phones and music players, among other devices.

Social Networking Trends:

With the advent of Web 2.0 and the meteoric rise of social networking websites (e.g. MySpace, Facebook), blogs, and virtual worlds (e.g. Second Life), a new consumer/viewer/user has begun to define itself in the form of having complete control over his/her shopping and learning experiences. This consumer/viewer/user likes to share his/her voice.

Advertising Trends:

Consumers have never been fond of the traditional advertising model which is forced on in-house television. When viewers began leaving the room during commercials, advertisers responded by increasing the volume so they their messages could be heard between rooms.

However, with the advent of disruptive technologies like TiVo and DVR, more and more viewers can bypass billions of dollars worth of televised advertisements, and advertisers have been forced to reconsider their model. As a result, advertisers have begun redirecting their attention towards other avenues and making use of new vehicles to deliver their messages and tout their brands.

The National Association of Broadcasters has taken steps to restrict paid product placement on TV and, as a result, the vast majority of television product placement is not paid-for. Still, the TV product placement industry has grown by 30 percent annually, according to PQ Media, and 2007 spending levels are estimated at $2.9 billion. According to PQ Media, spending on branded entertainment rose 14.7% last year to a record $22.3 billion. As investments in product placement continue to mount, reaching key audiences is becoming more and more difficult for manufacturers and brand marketers.

Additionally, brand marketers are putting increased emphasis on reaching coveted youth demographics and realizing positive return on their investments in product placement.

The Opportunity:

During the current, passive process of watching visual media, viewers have no immediate recourse for reacting to product placement (unless the visual media happens to be an infomercial) or connecting with other on-screen stimuli. If a person, place or thing in a movie, television program, or videogame catches a viewer's attention, regardless of what viewing device he/she uses, he/she has little recourse for learning more about the item/moments of stimulus and/or actively tracking his/her interests. Instead of obtaining direct access to information within the video content, viewers must resort to utilizing inefficient intermediaries (e.g. end credits, generic search engines, commercials, blogosphere, etc.) to learn more if they wish to learn more about visual, auditory and emotional stimuli within video content. Moogi.com seeks to fill the aforementioned void and make the visual media experience interactive.

The Moogi.com Solution

Moogi.com is an interactive Web 2.0 business which aims to connect viewers of episodic television and movies with web-based access to contextual metadata derived from everything that is heard, seen or felt directly from within the video content. We believe that the appropriate reaction to changes in the visual media business model and new trends in viewer interaction web technology is to create a business process that connects viewers with contextual based information relevant to any and everything that stimulates the viewer's visual, auditory or emotional senses during the content viewing process. In other words, we aim to connect the viewer with everything he sees, hears and feels on screen. To achieve this, we are developing an interactive platform that will aggregate metadata information from within the content and grant viewers unfettered access to stimuli metadata from within the content.

Our platform will manage the aggregation and dissemination of context-specific information relevant to key stimuli and metadata within episodic television and movie content, distributed online and through home-entertainment devices. Stimuli and metadata may be divided into six main categories:

Consumer products (e.g. clothing & apparel, electronics & media products, food & drink, art/design & furniture, in-scene advertisements, etc.). Audio (e.g. songs, musical scores, ring tones, dialogue, intradiegetic & extradiegetic sounds etc.). Cast and crew (e.g. information regarding characters/actors, directors, producers, writers, set designers, etc.). Locations (e.g. film studios, narrative locations, landmarks & tourist destinations, etc.). Other Information (e.g. narrative themes/concepts, plot lines, contemporary/historical information, filming techniques, other educational information, etc.). User-directed commentary relevant to episodic television and movies content. (e.g. comments, ratings, thematic discussions, etc.).

Our actionable, referential database empowers the viewer to explore video content and customize his/her viewing experience. The search functionality on Moogi.com, facilitated by our consolidated content metadata database, allows users to search for contextual information on stimuli within a specific episode, movie, or across all captured multimedia content.

Rather than being limited in a search capability that is limited to a script, our search capability empowers the viewer to search video content by the visual stimuli that appear on screen, the audio stimuli that are heard on screen, and the tagged metadata (e.g. comments, ratings, thematic discussions, etc.) that is generated by other users and captured in our database. Viewers will ultimately be able to search for this data across all cataloged media content or within a specific title, scene, shot and/or frame.

The Moogi.com interface, segmented across the key stimuli metadata categories, facilitates an interactive, transmedia, social networking experience that empowers users to contribute to customized social environments build around specific series, episodes, movies and genres. Each custom content environment is driven and enhanced by stimuli and other metadata aggregated by us.

We also aim to connect content producers, product developers, marketers, advertisers, research firms and corporations with quantitative metrics or contextual metadata relevant to episodic and movie content by licensing and customizing our platform to fit the research needs of each interested corporate client. For example: A corporate client could use our click-through data to measure the effectiveness of its product placement efforts. In this way, Moogi.com not only makes product placement immediately actionable and accessible to viewers from within the very video content in which it is displayed, but it also provides an actionable, quantifiable performance metric for product placement within video content. An advertiser could leverage our database to research the video content (e.g. episodic television shows, movies, etc.) in which its competitors are advertising. Clients could use our database to measure the effectiveness of other in-video promotion efforts (e.g. tourism boards & travel destinations, restaurants, clubs, etc.). Content producers could use our research and metrics to develop more accurate pricing structures around the placement of advertisements and promotions within their video content. Content producers could also use our database to gauge the popularity of any number of stimuli within video content (e.g. characters, locations, products, music, writing, narrative themes, etc.).

Establishing such an interactive media platform requires several key components, including technology, data, and strategic partnerships. Keeping this in mind, we propose to create/utilize several different forms of technology to fully enable the simple concept of creating an interactive environment driven by video entertainment. A complicated process that flows from a viewer: watching certain visual media; becoming stimulated by some form of stimuli (anything seen, heard, felt) and selecting that stimulus by clicking on a Moogi tool or a web-enabled viewing device (e.g. television, computer, website, DVD/BluRay player, video game console, PDA, cell phone, portable music device, etc.); visiting Moogi.com (or receiving instantaneous data on selected stimuli on the viewer's content browsing device); learning more about stimuli and, when applicable, acting upon items of interest (e.g. by purchasing a product/service, listening to a song, learning a recipe, identifying an interior design scheme, etc.); and interacting with other viewers

At Moogi.com, the viewer is presented with exhaustive content from the moment(s) he/she selected, and he/she can also interact with any other Moogi user who shares an affinity for the same show/film/game.

The steps outlined above will help drive the successful operation of our business. A more detailed overview of how this concept will be applied to broadband visual media content, accompanied by graphical representations for each section is detailed below.

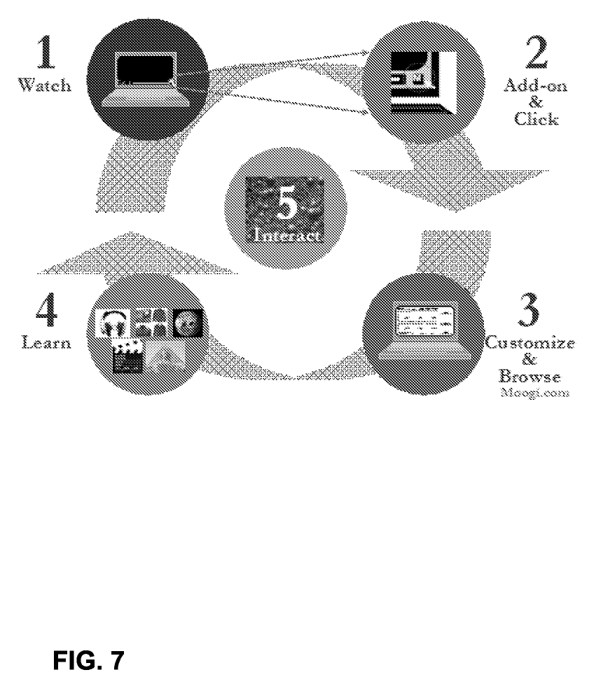

FIG. 7 is an example block diagram illustrating an overview of the Viewer's Process. The viewer's process includes five steps. Step #1 is a watching step. Step #2 is an adding on and clicking step. Step #3 is a customizing and browsing step. Step #4 is a learning step. And step #5 is an interacting step.

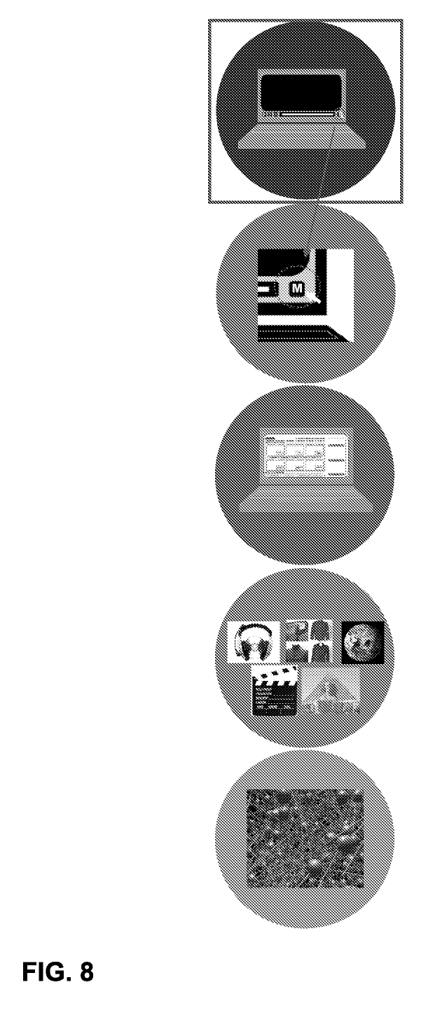

The watching step (step 1) is shown with respect to FIG. 8. Particularly the block that is encompassed by a square. An increasing number of major television broadcast & cable networks and movie studios are streaming entertainment video programming through the web-based technologies. The growing trend of web-based content availability is fueling a progressive increase in online viewing—which, in turn, encourages networks to continue expanding the online availability of video media content. A recent research study estimates that currently, approximately 10% of television viewers also watch network programming through online medium. This trend is expected to realize a 5% year-on-year increase for the next five years. In 2025, the same research study estimates that roughly 25% of television audiences will watch their favorite network programs online. Viewers may watch this content on a web-enabled device, a content provider's website, or in an embedded browser on Moogi.com.

During the process of watching television or a movie, many aspects of the content may stimulate a viewer's interest. Stimuli may include: Consumer Products such as Clothing and Apparel, Electronics & Media, Design (e.g. furniture, art, etc.), Food & Drink (e.g. groceries, etc.), In-Scene Advertisements. Stimuli may also include Audio such as Songs, Musical Scores & Ring Tones, Dialogue, Intradiegetic & Extradiegetic Sounds. Stimuli may also include Locations such as Filmed Set Location & Narrative Location (e.g. A film set in Paris may be shot in a Hollywood studio), Landmarks & Tourist Destinations (e.g. monuments, restaurants, bars, museums, etc.), Cast and Crew. Stimuli may also include Character Information such as Actor, Director, Writer Profiles, Production, Editing, Set Design, Cinematography, etc. Stimuli may also include Other Information such as Plot Lines, Narrative Themes/Concepts, Contemporary/Historical Info, and Filming Techniques. Stimuli may also include Other educational information (e.g. food recipes, etc.). Stimuli may also include User-directed commentary such as Comments & Ratings and Thematic Discussions.

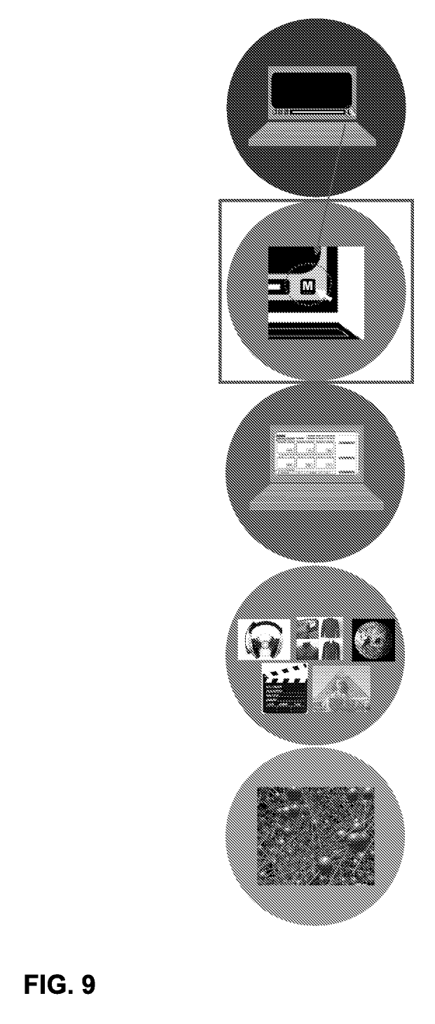

The adding on and clicking step is shown with respect to FIG. 9. Particularly, the block that is compassed by a square. During the current, passive process of watching video media content (online or through in-home entertainment hardware), viewers are unable to Select or track moments when a specific stimulus present itself, or Interact with a given stimulus should it, in fact, interest the viewer.

We have developed a method that will allow viewers to select and track every moment of stimulation during the online viewing experience and allow the viewer to interact with stimuli from all selected moments. The viewer may choose to explore selected moments/stimuli immediately (i.e. “Instant Gratification” mode) or store selected moments/stimuli at Moogi.com, to be perused later (e.g. “Personal Cart” mode).

An embedded Moogi tool, icon, or widget on a content provider's website (or, web-enabled viewing device) functions as a bridge to Moogi's back-end content database. The tool allows the viewer to create an infinite number of custom keys, each of which opens the door to different interactive experiences on Moogi.com.

Each time a viewer clicks on a Moogi tool, the following information will be transmitted to Moogi.com: The title of the video content which was being watched by the viewer when the tool was clicked (e.g. file name, movie title, television series and episode title, video game title, etc.). The specific frame for the exact moment when the viewer clicked on the tool (e.g. Time code, Chapter, Scene, etc.).

If the viewer has selected “Personal Cart” mode, additional information will transmit: The viewer's account profile (e.g. name, login, cookie, IP address, etc.). This will trigger the direction of information from the video player to the Moogi.com database, where the viewer's selections will be tracked and stored. The data will then be linked directly to Moogi's back-end database where the viewer's selected inputs would then be compared against our database. The result will be one of three outcomes: The input data finds a match (or matches) in our database and the viewer opts to look at the results immediately; The input data finds a match (or matches) in our database and the viewer opts to store the results in his/her “cart” and then views his/her cart later; The input data does not find a match in our database.

Eventually, users will be able to select a specific object/location on-screen. At such time, this on-screen location data will also be transmitted from the viewing device to Moogi.com.

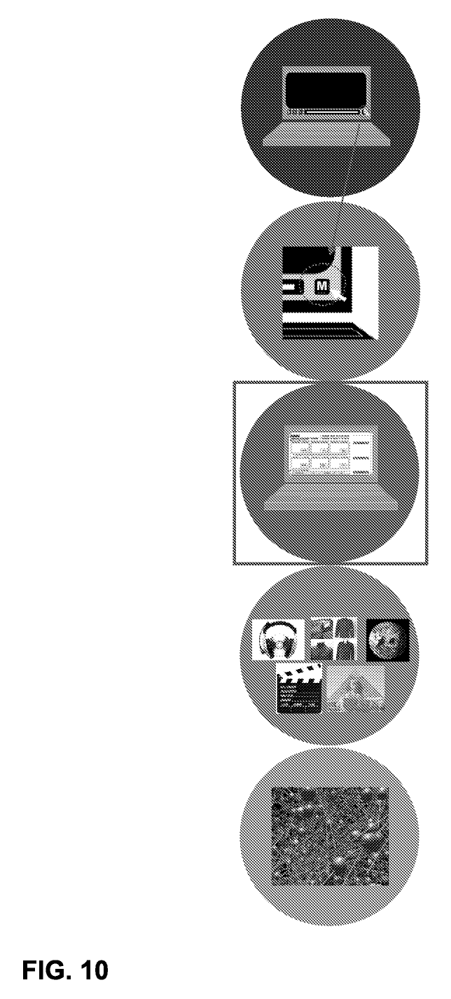

The browsing step is shown with respect to FIG. 10. Particularly, the block that is compassed by a square. Because Moogi's objective is to empower the viewer to maximize his/her viewing experience, he/she may opt to view his/her chosen item(s) and/or moment(s) immediately, or at a later time.

If the viewer has selected “Instant Gratification” mode, he/she will immediately be provided with information about every person/place/thing on screen. This information can be presented to the viewer in either a pop-up window, or as an embedded part of a web browser or video player/application.

If the viewer has selected “Personal Cart” mode, each stimulus that he/she clicks on will be stored as new entry in the his/her personal cart and the viewer will be free to visit Moogi.com (or, when applicable, access the embedded personal cart on his/her viewing device) and review cart selections at his/her leisure.

Once logged-into his/her personal account, the member will be presented with a list of all the video content which he/she tagged. From this list, the Moogi member will be able to interact in multiple ways with information relevant to the list.

For example, if a viewer uses a Moogi tool while watching two different shows, both shows—as well as the selected moment(s) from each show—will be listed in the viewer's cart. If the viewer then chooses to view a moment from one of the two shows, the Moogi portal will provide the viewer with a list of stimuli relevant to that specific moment/show and enable the viewer to personalized his/her interaction with the selected moment of stimulus. The viewer will also have the option of saving specific moments, items or themes to his/her personal account.

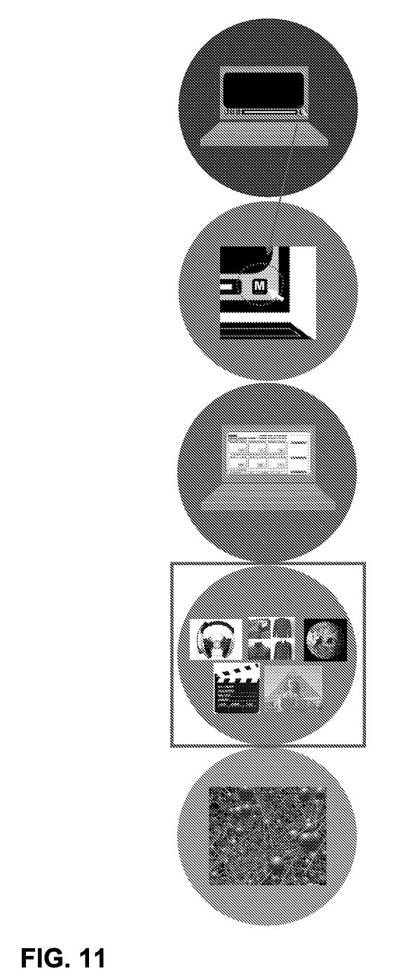

The learning step is shown with respect to FIG. 11. Particularly, the block that is compassed by a square. By connecting our media database to any a web-enabled device capable of connecting a user with a visual media (e.g. television, computer, website, DVD/BluRay player, video game console, PDA, cell phone, portable music device, etc.), we will give the viewer the real-time ability to freely select, research and/or purchase a wide spectrum of stimuli that he/she sees, hears or feels in a television show, major motion picture, video game, or other distributed visual media.

From a user's standpoint, the viewer will be able to interact with visual media, in real-time or at his/her leisure, and gain deeper insight into everything on screen that stimulates his/her senses. From a consumer's standpoint, not only will the viewer finally be able to find out what kind of suit the protagonist is wearing, what song is playing, or where the picturesque beach is—but he/she will also be able to buy the suit, download the song and make travel reservations to the beach. From a fan's standpoint, the viewer will be able to tag and/or rate moments/themes/items and personalize his/her own viewing experience, while intertwining it with the experiences of others with similar (or dissimilar) interests and preferences. From a learner's standpoint, viewers will be able to gather information on items, areas or concepts of interest.

Although the user is exposed to everything he/she sees and hears on-screen, this platform lets the viewer decide what stimuli he/she wants to learn more about and how he/she would like to respond to the way that visual media makes him/her feel. In this way, the viewer does not feel alienated as a fan or bombarded as a learner or spammed as a consumer. Rather, he/she is empowered as an individual.

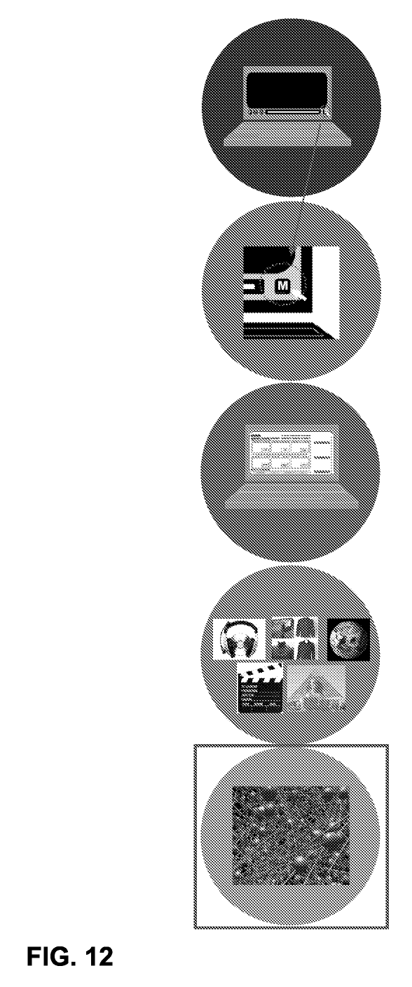

The interacting step is shown with respect to FIG. 12. Particularly, the block that is compassed by a square. When users select moments of stimulus and Moogi provides them with relevant information, we see an opportunity to drive interaction further to peer-to-peer interaction with other Moogi members who may share similar interests and/or moments of stimulus.

Moogi.com will maintain an additional feature which will allow members to grant other Moogi members partial or complete access to each-other's pages. Furthermore, the Moogi database also catalogs issues relevant to different moments of stimulus. We anticipate that these issues (in addition to consumer products and other stimuli) will spur discussion, engender peer-to-peer interaction and help foster a new kind of online community. This social interaction must be mediated and encouraged in order to create an effective community interested in facilitating the evolution of television viewing from a passive process to a fully-interactive experience.

As a summary of the concept, Moogi.com seeks to make the act of watching visual entertainment (via DVD/BluRay, broadband-streamed sources, televisions, computers, gaming systems, hand-held devices, cellular phones, etc.) personal and interactive. The scope of visual entertainment ranges from television programming to webisodes, feature cinema and video games. We aim to give viewers of these mediums of entertainment the ability to directly interact with any and every on-screen stimulus (i.e. anything that is seen, heard or felt by the viewer).

Our goal is to develop an environment which will facilitate an interaction and satisfy viewer curiosity which is driven by stimuli from visual entertainment. Moogi.com hopes to mediate social interaction between its users around the world. Driven first by interaction with consumer products, narrative content and/or popular themes relating to the television shows, Moogi will enable its members to share interests, themes, or ideas with one another.

We are focused on giving viewers the autonomous choice of selecting and interacting with any content, ideas or issues that appears in visual entertainment. Such stimuli can range from consumer products, to narrative content, locations, audio cues, and more. Because we are interested in the effects of television on society, an additional value proposition to our members is the opportunity to interact with issues such as episodic/narrative themes, content-driven social implications, games, and more. The objective of storing so much information within the Moogi database is to establish a diverse, robust, and user-driven environment for interaction and learning.

Moogi will allow viewers to direct the evolution of the normally passive process of viewing television, into an interactive process driven by social interaction. It is our view that the evolution of mediums for distributing visual media programming is both creating the need and enabling the possibility of Moogi's success. Having unlimited access to stimulating content in visual entertainment will enable ongoing peer-to-peer interaction between viewers. Moogi's success may eventually steer content providers towards a model wherein viewers/learners/consumers drive the direction of television programming and other visual media.

The techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (“RAM”) such as synchronous dynamic random access memory (“SDRAM”), read-only memory (“ROM”), non-volatile random access memory (“NVRAM”), electrically erasable programmable read-only memory (“EEPROM”), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (“DSPs”), general purpose microprocessors, application-specific integrated circuits (“ASICs”), field programmable logic arrays (“FPGAs”), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (“CODEC”).

1. A method comprising:
receiving, at a server, metadata from a user device, wherein the metadata includes identification of a media content file;
determining a scene within the media content file based on the metadata;
determining stimuli information associated with one or more stimuli within the media file; and
transmitting the stimuli information to the user device.

2. The method of claim 1, wherein the metadata comprises media content identification and one of a timestamp and a scene number associated with the media content.

3. The method of claim 1, wherein stimuli information comprises one of a consumer product, a location, a narrative content associated with the media content, and an educational item.

4. The method of claim 1, wherein the scene comprises one or more frames.

5. The method of claim 1, further comprising:
receiving the media content file comprising a plurality of scenes;
extracting metadata from each one of the plurality of scenes;
extracting one or more stimuli from each one of the plurality of scenes;
generating stimuli information for each one of the one or more extracted stimuli;
associating the stimuli information for each one of the plurality of scenes with the extracted metadata for each one of the plurality of scenes; and
storing the associated stimuli information and the extracted metadata for each one of the plurality of scenes of the media content.

6. The method of claim 5, wherein the extracted metadata comprises one of a plurality of timestamps and a plurality of scene numbers for each one of the plurality of scenes of the media content file.

7. The method of claim 5, wherein the one or more stimuli comprises a consumer product, an audio element, a location element, an identification of cast and crew, a narrative content element, and an educational item.

8. The method of claim 5, wherein the stimuli information comprises information for the one or more extracted stimuli.

9. The method of claim 5, further comprising searching for stimuli information based on a user input.

10. A computer-readable storage medium comprising instructions that cause one or more processors to:
receive metadata from a user device, wherein the metadata includes identification of a media content file;
determine a scene within the media content file based on the metadata;
determine stimuli information associated with one or more stimuli within the media file; and
transmit the stimuli information to the user device.

11. The computer-readable storage medium of claim 10, wherein the metadata comprises media content identification and one of a timestamp and scene number of the media content.

12. The computer-readable storage medium of claim 10, wherein stimuli information comprises one of a consumer product, an audio element, a location element, an identification of cast and crew, a narrative content element, and an educational item.

13. The computer-readable storage medium of claim 10, wherein the scene comprises one or more frames.

14. A server comprising:
a transceiver configured to receive metadata from a user device, wherein the metadata includes identification of a media content file; and
a processor configured to determine a scene within the media content file based on the metadata, and determine stimuli information associated with one or more stimuli within the media file, wherein the processor causes the transceiver to transmit the stimuli information to the user device.

15. The server of claim 14, wherein the metadata comprises media content identification and one of a timestamp and scene number associated with the media content.

16. The server of claim 14, wherein stimuli information comprises one of a consumer product, a location element, a narrative content associated with the media content, and an educational item.

17. The server of claim 14, wherein the scene comprises one or more frames.

18. A server of claim 14, wherein the transceiver is configured to receive the media content file comprising a plurality of scenes and the processor is configured to extract metadata from each one of the plurality of scenes, extract one or more stimuli from each one of the plurality of scenes, generate stimuli information for each one of the one or more extracted stimuli, associate the stimuli information for each one of the plurality of scenes with the extracted metadata for each one of the plurality of scenes, the server further comprising a memory configured to store the associated stimuli information and the extracted metadata for each one of the plurality of scenes.

19. The server of claim 18, wherein the extracted metadata comprises one of a plurality of timestamps and a plurality of scene numbers for each one of the plurality of scenes of the media content file.

20. The server of claim 19, wherein the one or more stimuli comprises a consumer product, an audio element, a location element, an identification of cast and crew, a narrative content element, and an educational item.

21. The server of claim 19, wherein the stimuli information comprises information for the one or more extracted stimuli.

22. The server of claim 19, wherein the processor is further configured allow a user to search for stimuli information based on a user input.

23. A system comprising:
one or more user devices, wherein each one of the user devices comprises:
a display module configured to display media content of the media content file on a user device;
a first transceiver configured to receive a user selection for a scene of the media content in response to a stimulus within the media content; and
a first processor configured to extract metadata associated with the selected scene, wherein the processor causes the transceiver to transmit the metadata; and
a server, wherein the server comprises:
a second transceiver configured to receive metadata from the one or more user devices, wherein the metadata includes identification of a media content file; and
a second processor configured to determine a scene within the media content file based on the metadata, and determine stimuli information associated with one or more stimuli within the media file, wherein the processor causes the transceiver to transmit the stimuli information to the one or more user devices.
